(19) United States
(12) Patent Application Publication
(10) Pub. No.: US 2025/0227728 A1
(43) Pub. Date: Jul. 10, 2025

(54) SL UE RELAY ENHANCEMENTS

(71) Applicant: Fraunhofer-Gesellschaft zur Förderung der angewandten Forschung e.V., München (DE)

(72) Inventors: Julian POPP, Erlangen (DE); Mehdi HAROUNABADI, Erlangen (DE); Elke ROTH-MANDUTZ, Erlangen (DE); Negar HAJIJALILI, Erlangen (DE); Martin LEYH, Erlangen (DE)

(21) Appl. No.: 19/093,628

(22) Filed: Mar. 28, 2025

Related U.S. Application Data
(63) Continuation of application No. PCT/EP2023/077046, filed on Sep. 29, 2023.

(30) Foreign Application Priority Data
Sep. 29, 2022 (EP) 22198888.4

(51) Int. Cl. H04W 72/25; H04W 36/00

(52) U.S. Cl. CPC H04W 72/25; H04W 36/0079

(57) ABSTRACT

An embodiment provides a first remote UE [e.g., source UE] of a wireless [e.g., radio based] communication system [e.g., 5G/NR communication system], wherein the first remote UE is configured to operate in a sidelink mode of operation [e.g., 5G/NR sidelink mode 1 or mode 2]. Here, the first remote UE is configured to establish a connection with a second remote UE [e.g., target UE or a group of target UEs] via a Relay UE, and to initiate a sidelink establishment procedure; wherein the sidelink establishment procedure is mandated to start.

### CROSS-REFERENCE TO RELATED APPLICATIONS

This application is a continuation of copending International Application No. PCT/EP2023/077046, filed Sep. 29, 2023, which is incorporated herein by reference in its entirety, and additionally claims priority from European Application No. 22198888.4, filed Sep. 29, 2022, which is also incorporated herein by reference in its entirety.

### TECHNICAL FIELD

Embodiments of the present application relate to the field of wireless communication, and more specifically, to wireless communication between two UEs (e.g., remote UEs, also referred to as source UE and a target UE) via a Relay UE. Some embodiments relate to SL Relay UE Enhancements.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2a is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2b is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2b which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2a, in addition to the NR mode 1 or LTE mode 3 UEs also NR mode 2 or LTE mode 4 UEs are present.

Naturally, it is also possible that the first vehicle is covered by the gNB, i.e. connected with Uu to the gNB, wherein the second vehicle is not covered by the gNB and only connected via the PC5 interface to the first vehicle, or that the second vehicle is connected via the PC5 interface to the first vehicle but via Uu to another gNB.

For sidelink Relay UE the link establishment procedure typically consists of two main steps: first relay discovery, followed by (re-)selection. This “usual” type of link establishment procedure causes the exchange of multiple signaling messages resulting in signaling overhead and increased latency on the RAN.

One idea on how to reduce these problems is to combine both RAN procedures into one, i.e. an integrated link establishment procedure, where relay discovery and (re-)selection are combined. This integrated procedure would accelerate the link establishment procedure and avoiding signaling overhead. Instead of separate procedures a new integrated RAN UE-to-UE link establishment procedure is proposed, to reduce latency and overhead. Resulting from that a new or adapted signaling exchange for link establishment is required.

Therefore, there is the need for improvements with respect to Relay UE.

### SUMMARY

An embodiment may have a first remote UE [e.g., source UE] of a wireless [e.g., radio based] communication system [e.g., 5G/NR communication system], wherein the first remote UE is configured to operate in a sidelink mode of operation [e.g., 5G/NR sidelink mode 1 or mode 2], wherein the first remote UE is configured to establish a connection with a second remote UE [e.g., target UE or a group of target UEs] via a UE-to-UE-relay UE operated in the sidelink mode, and to initiate a sidelink establishment procedure; wherein the sidelink establishment procedure is mandated to start
by an external entity, like a base station of the communication system, a road side unit of the communication system, the second UE or another UE of the communication system, the UE-to-UE-relay UE, or
by action of a higher layer of the first UE [e.g., self-initiated] or
in case of a radio link failure or the risk of a radio link failure.

Another embodiment may have a UE-to-UE-relay UE of a wireless [e.g., radio based] communication system [e.g., 5G/NR communication system], wherein the UE-to-UE-relay UE is configured to operate in a sidelink mode of operation [e.g., 5G/NR sidelink mode 1 or mode 2], wherein the UE-to-UE-relay UE operated in the sidelink mode is configured to establishing a connection between a first remote UE [e.g., source UE] and a second remote UE [e.g., target UE or a group of target UEs], and to initiate a sidelink establishment procedure; wherein the sidelink establishment procedure is mandated to start by a base station of the communication system, a road side unit of the communication system, the second UE or another UE of the communication system, the UE-to-UE-relay UE or a higher layer of the first UE [e.g., self-initiated].

According to another embodiment, a method for performing wireless [e.g., radio based] communication [e.g., within 5G/NR communication system] using at least first remote UE [e.g., source UE] and a UE-to-UE-relay UE, wherein the first remote UE is configured to operate in a sidelink mode of operation [e.g., 5G/NR sidelink mode 1 or mode 2], may have the steps of: establishing a connection with a second remote UE [e.g., target UE or a group of target UEs] via a UE-to-UE-relay UE operated in the sidelink mode, and initiating a sidelink establishment procedure; wherein the sidelink establishment procedure is mandated to start
by an external entity, like a base station of the communication system, a road side unit of the communication system, the second UE or another UE of the communication system, the UE-to-UE-relay UE, or
by action of a higher layer of the first UE [e.g., self-initiated] or
in case of a radio link failure or the risk of a radio link failure.

Another embodiment may have a non-transitory digital storage medium having stored thereon a computer program for performing a method for performing wireless [e.g., radio based] communication [e.g., within 5G/NR communication system] using at least first remote UE [e.g., source UE] and a UE-to-UE-relay UE, wherein the first remote UE is configured to operate in a sidelink mode of operation [e.g., 5G/NR sidelink mode 1 or mode 2], the method having the steps of: establishing a connection with a second remote UE [e.g., target UE or a group of target UEs] via a UE-to-UE-relay UE operated in the sidelink mode, and initiating a sidelink establishment procedure; wherein the sidelink establishment procedure is mandated to start
by an external entity, like a base station of the communication system, a road side unit of the communication system, the second UE or another UE of the communication
system, the UE-to-UE-relay UE, or
by action of a higher layer of the first UE [e.g., self-initiated] or
in case of a radio link failure or the risk of a radio link failure,
   when the computer program is run by a computer.

It is noted that the information in the above section is only for enhancing the understanding of the background of the invention and therefore it may contain information that does not form conventional technology and is already known to a person of ordinary skill in the art.

### BRIEF DESCRIPTION OF THE DRAWINGS

Embodiments of the present invention are described herein making reference to the appended drawings, in which:

FIGS. 1a and 1b show schematic representations of an example of a wireless communication system;

FIGS. 2a and 2b show schematic representations of in-coverage and out of coverage scenario in which UEs directly communicating with each other are connected to a base station;

FIG. 3 shows schematically layer-2 link establishment procedure (TS 23.287) to discuss the basis of embodiments;

FIG. 4 shows schematically a connection establishment procedure integrating Relay UE discovery and selection. [TR 23.752] according to embodiments;

FIG. 5 shows schematically a connection establishment procedure after Relay UE discovery and selection [TR 23.752] according to embodiments;

FIG. 6 shows schematically a PC5 link establishment via U2U Relay according to embodiments; and

FIG. 7 shows schematically a computer implementation.

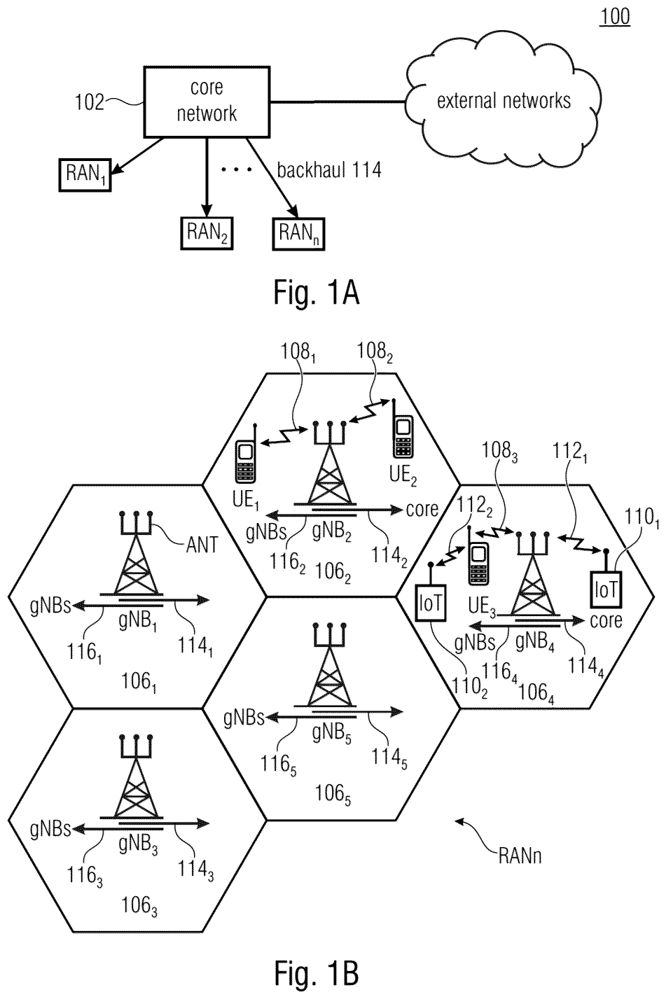

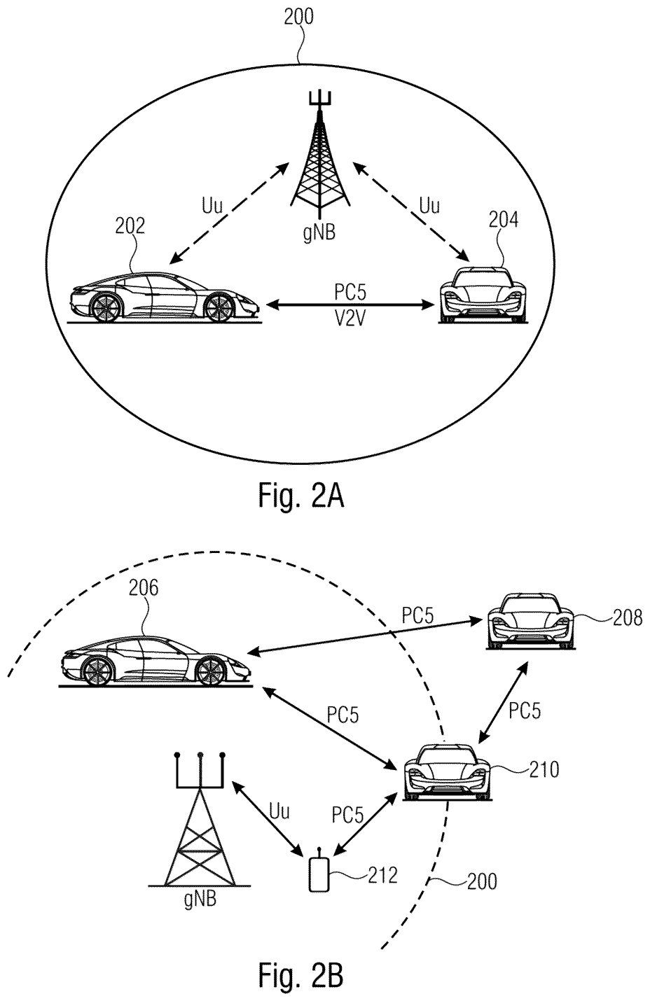

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As already indicated in the introductory portion, in a UE-to-Network relay, the target/destination for the remote UE is clear-it is the network. In Relay UE, e.g. a UE-to-UE relay, the target UE can be connected to any relay UE. For Relaying there arises the issue of how to find the correct relay UE that has the target/destination UE connected to it.

According to TR 23.752, there are in general three methods for UE-to-UE discovery:
1. Direct Communication Request (unicast)
2. Relay Discovery/Selection
3. Integrated UE Discovery and Relay Discovery/Selection in PC5

For unicast link establishment two methods (service-oriented and user-oriented) are supported using the procedure described in clause 6.3.3 of TS 23.287:

Layer-2 link establishment over PC5 reference point

This procedure is also described in clause 6.4.3.1 TS 23.304

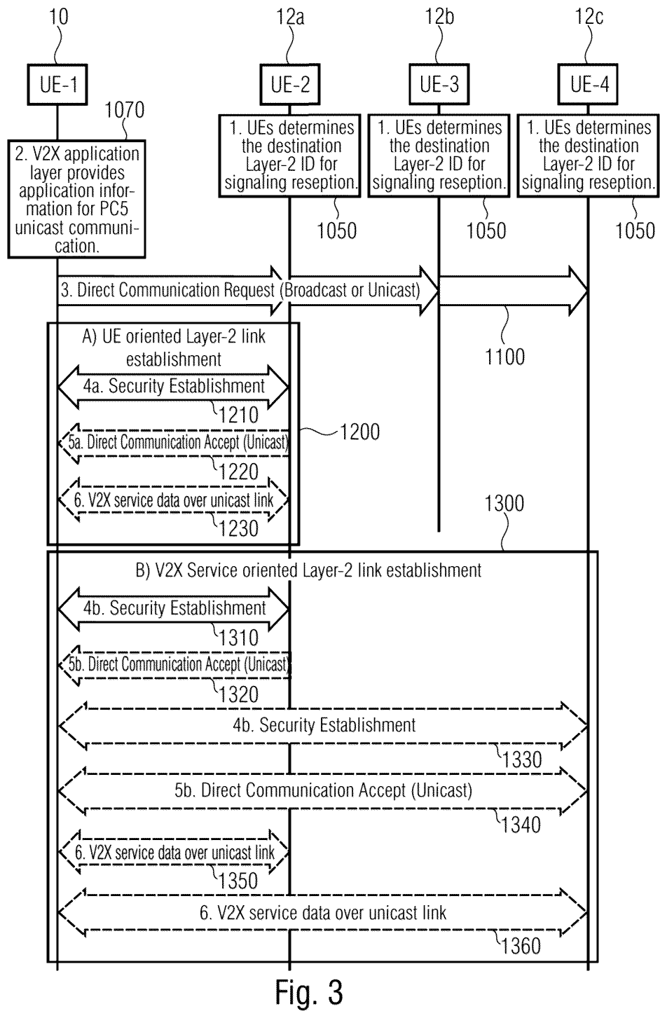

FIG. 3 shows the layer-2 link establishment procedure for unicast mode of V2X communication over PC5 reference point.

FIG. 3 shows a schematically layer-2 link establishment procedure between a first UE 10 and one or more other UEs 12a, 12b and 12c. The UEs 12a, 12b and 12c are configured to determine the destination ID or destination layer-2 ID for signalling reception as illustrated by the blocks marked by the reference numeral 1050. By use of the UE 10, the V2X application provides application information for PC5 unicast communication (cf. step 1075). Starting from this the UE 10 can output a direct communication request, e.g. via broadcast and unicast. This step is marked by the reference numeral 1100. The two steps 1200 for UE orientated layer-2 link establishment and 1300 for V2X to have this orientated layer-2 link establishment will be discussed in detail below taking reference to FIG. 3.

Each UE 10, 12a, 12b, 12c has one or more UE IDs, like Layer-2 IDs for V2X communication over PC5 reference point, consisting of:
Source ID or Source Layer-2 ID(s); and
Destination ID or Destination Layer-2 ID(s).

Source and destination ID, like Layer-2 IDs (in general UE ID) are included in layer-2 frames sent on the layer-2 link of the PC5 reference point identifying the layer-2 source and destination of these frames. Source ID or Layer-2 IDs are typically self-assigned or assigned by the network or another UE, like the UE 10, 12a, 12b, 12c originating the corresponding layer-2 frames.

The selection of the source and destination ID or Layer-2 ID(s) by a UE depends on the communication mode of V2X communication over PC5 reference point for this layer-2 link.
1. The UE(s) determine the destination ID (Layer-2 ID) for signalling reception for PC5 unicast link establishment (cf. 1050).
2. The V2X application layer in UE-1 provides application information for PC5 unicast communication. The application information includes the V2X service type(s) and the initiating UE's Application Layer ID. The target UE's Application Layer ID may be included in the application information (cf. 1075).
3. UE-1 sends a Direct Communication Request message 1100 to initiate the unicast layer-2 link establishment procedure. The Direct Communication Request message may include one or more of the following:
   Source User Info: the initiating UE's Application Layer ID (i.e. UE-1's Application Layer ID).
   If the V2X application layer provided the target UE's Application Layer ID in step 2, the following information is included:
   Target User Info: the target UE's Application Layer ID (i.e. UE-2's Application Layer ID).
   V2X Service Info: the information about V2X service type(s) requesting Layer-2 link establishment.
   Security Information: the information for the establishment of security.

The destination ID (Layer-2 ID) may be broadcast or unicast ID or Layer-2 ID. When unicast Layer-2 ID is used, the Target User Info shall be included in the Direct Communication Request message.

Consequence: A new field is proposed to be added in the direct communication request to indicate whether relays can be used in the communication. The field can be called relay_indication. When a UE wants to broadcast a direct communication request, it indicates in the message whether a Relay UE could be used. For Release 17, it is assumed that the value of the indication is restricted to single hop. [2]
4. Security with UE-1 is established as below (cf. 1100):
   4a. If the Target User Info is included in the Direct Communication Request message, the target UE, i.e. UE-2, responds by establishing the security with UE-1 (cf. 1210).
   4b. If the Target User Info is not included in the Direct Communication Request message, the UEs that are interested in using the announced V2X service type(s) over a PC5 unicast link with UE-1 responds by establishing the security with UE-1 (cf. 1310). Upon receiving the security establishment procedure messages, UE-1 obtains the peer UE's ID or Layer-2 ID for future communication, for signalling and data traffic for this unicast link.
5. A Direct Communication Accept message is sent to UE-1 by the target UE(s) that has successfully established security with UE-1:
   5a. (UE oriented Layer-2 link establishment) If the Target User Info is included in the Direct Communication Request message, the target UE, i.e. UE-2 responds with a Direct Communication Accept message if the Application Layer ID for UE-2 matches (cf. 1220).
   5b. (V2X Service oriented Layer-2 link establishment) If the Target User Info is not included in the Direct Communication Request message, the UEs that are interested in using the announced V2X Service(s) respond to the request by sending a Direct Communication Accept message (cf. 1320, 1340: UE-2 and UE-4 in FIG. 3).

The Direct Communication Accept message includes:
Source User Info: Application Layer ID of the UE sending the Direct Communication Accept message.
QOS Info: the information about PC5 QoS Flow(s) requested by UE-1. For each PC5 QoS Flow, the PFI, the corresponding PC5 QoS parameters (i.e. PQI and conditionally other parameters such as MFBR/GFBR, etc.) and the associated V2X service type(s).
If IP communication is used:
   IP Address Configuration: For IP communication, IP address configuration is required for this link and indicates one of the following values:
“IPv6 Router” if IPv6 address allocation mechanism is supported by the target UE, i.e., acting as an IPV6 Router; or.
“IPv6 address allocation not supported” if IPv6 address allocation mechanism is not supported by the target UE.
   Link Local IPV6 Address: a link-local IPV6 address formed locally if the target UE does not support the IPV6 IP address allocation mechanism, i.e. the IP Address Configuration indicates “IPv6 address allocation not supported”, and UE-1 included a link-local IPv6 address in the Direct Communication Request message. The target UE shall include a non-conflicting link-local IPv6 address.
6. V2X service data is transmitted over the established unicast link as below (cf. 1230, 1350, 1360):

The PC5 Link Identifier, and PFI are provided to the AS layer, together with the V2X service data.

Optionally in addition, the ID or Layer-2 ID information (i.e. source Layer-2 ID and destination Layer-2 ID) is provided to the AS layer.

NOTE: It is up to UE implementation to provide the ID or Layer-2 ID information to the AS layer.
UE-1 sends the V2X service data using the source ID or Layer-2 ID (i.e. UE-1's Layer-2 ID for this unicast link) and the destination ID or Layer-2 ID (i.e. the peer UE's Layer-2 ID for this unicast link).
NOTE: PC5 unicast link is bi-directional, therefore the peer UE of UE-1 can send the V2X service data to UE-1 over the unicast link with UE-1. [1]

### RRC Perspective: TS 38.331

The PC5-RRC signalling, can be initiated after its corresponding PC5 unicast link establishment.

For each PC5-RRC connection of unicast, one sidelink SRB (i.e. SL-SRB0) is used to transmit the PC5-S message(s) before the PC5-S security has been established. One sidelink SRB (i.e. SL-SRB1) is used to transmit the PC5-S messages to establish the PC5-S security. One sidelink SRB (i.e. SL-SRB2) is used to transmit the PC5-S messages after the PC5-S security has been established, which is protected. One sidelink SRB (i.e. SL-SRB3) is used to transmit the PC5-RRC signalling, which is protected and only sent after the PC5-S security has been established. One sidelink SRB (i.e. SL-SRB4) is used to transmit/receive the NR sidelink discovery messages.

5G ProSe Relay UE Discovery parameters include:
User Info ID: For Model A, this corresponds to the Announcer Info parameter when the UE is acting as an announcing UE. For Model B, this corresponds to the Discoverer Info in Solicitation messages and the Discoveree Info in Response messages, when the UE is acting as a discoverer or discoveree UE respectively.
Relay Service Code(s): A Relay Service Code identifies a connectivity service the ProSe Relay UE provides to applications. The Relay Service Codes are configured in the ProSe Relay UEs that provide connectivity services to applications. The Relay Service Codes are configured in the Remote UEs interested in related connectivity services. [TR 23.700-33] 6.8.2.4

Connection establishment for L2 Relay UE includes two cases:
Connection establishment integrating Relay UE discovery and selection, and
Connection establishment after Relay UE discovery and selection TR 23.752

### EMBODIMENTS

### Embodiment 1: PC5 Link Establishment Procedure for Relay UE Discovery and (Re-) Selection

To discover and (re-)select a sidelink Relay UE, the PC5 link establishment procedure can be applied. The procedure can be used with integrated sidelink discovery and relay (re-)selection procedures. The entity which initiates the PC5 link establishment procedure can be at least one out of the following entities:
Source UE
Target UE
Candidate relay UE

A UE can be mandated to start the PC5 link establishment procedure for relay (re-)selection by at least one of the followings:
A Base station
A road side unit
Another UE (e.g. source UE, target UE, relay UE)
Higher layers of the respective UE

The configuration of PC5 link establishment procedure for sidelink relay discovery and (re-) selection can be provided by at least one out of followings:
Base station (RAN)
Network (core network)
Pre-configuration
Higher layers
UE (e.g. source UE, target UE, relay UE)

PC5 Link establishment can be done in:
In-coverage scenario
Out-of-coverage scenario
Partial coverage

An embodiment provides a first remote UE [e.g., source UE] of a wireless [e.g., radio based] communication system [e.g., 5G/NR communication system], wherein the first remote UE is configured to operate in a sidelink mode of operation [e.g., 5G/NR sidelink mode 1 or mode 2]. Here, the first remote UE is configured to establish a connection with a second remote UE [e.g., target UE or a group of target UEs] via a Relay UE, and to initiate a sidelink establishment procedure; wherein the sidelink establishment procedure is mandated to start
by an external entity, like a base station of the communication system, a road side unit of the communication system, the second UE or another UE of the communication
system, the Relay UE (e.g. a UE performing relaying or a UE-to-UE relay), or
by action of a higher layer of the first UE [e.g., self-initiated] or
in case of a radio link failure or the risk of a radio link failure.

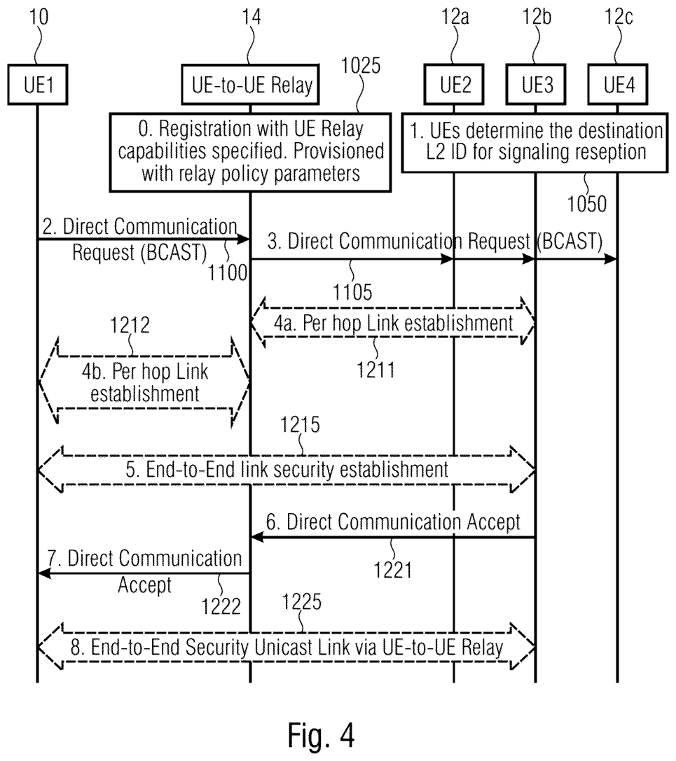

With respect to FIG. 4 this procedure will be discussed taking reference to the communication system having the UE 10 communicating with the UEs 12a, 12b and/or 12c via the relay 14.

In an initial step 1025 a registration with UE relaying capabilities is specified (provisioned with relay policy parameters). This step may be performed by the relay or by use of the relay or by involving the relay 14. The UEs 12a, 12b and/or 12c can then perform the step 1050. This step might be comparable to the step 1050 as discussed in context of FIG. 3. After that the following procedure can for example, be done. The UE 10 provides a direct communication request (BCAST) in the step 1100 to the relay 14 which, vice versa forwards this request as direct communication request (BCAST) 1105 after that the link establishment 1211 and 1212 is done first between the UEs 12a, 12b and/or 12c and the relay 14 and then between the relay 14 and the UE 10. This means that this step is divided into two portions 1211 and 1212. The result is an end-to-end link security establishment 1215 comparable to the security establishment 1210 as discussed in context of FIG. 3. The direct communication accept is again divided into two portions 1221 and 1222. The result is an end-to-end secured unicast link via UE to UE relay 1225.

Below, optional features enhancing this procedure will be discussed.

According to embodiments, the first remote UE comprises a source UE and wherein the second remote UE comprises a target UE or a group of target UEs. According to embodiments, the first remote UE comprises a target UE or a group of target UEs and wherein the second remote UE comprises a source UE. According to embodiments, the first remote UE, the second remote UE or the Relay UE comprises an entity configured to determine a radio link failure or the risk of a radio link failure.

According to embodiments, the external entity communicates with the first remote UE using resources of layer 2/3 or of layer 1 for exchanging condition information or exchanging messages.

### Embodiment 2: Procedure to Integrate Relay Discovery and (Re-)Selection in PC5 Link Establishment

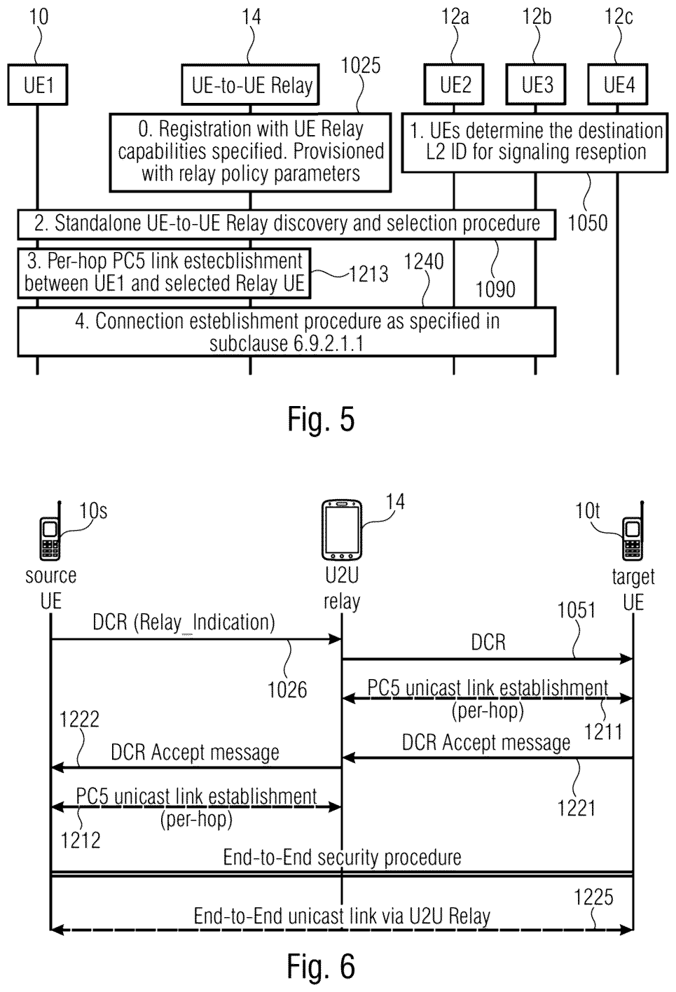

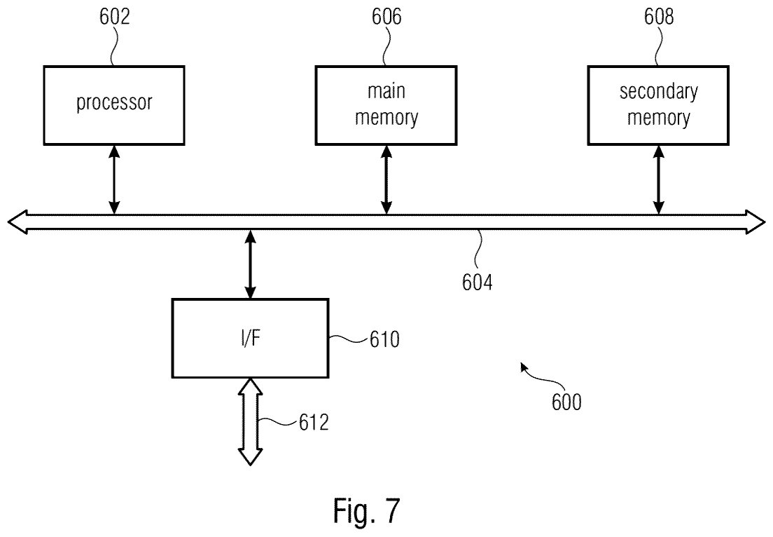

FIG. 5 illustrates the procedure to be used for connection establishment after relay UE discovery and selection.

FIG. 5 starts from the scenario, where the entities 10, 14, 12a, 12b and 12c are interacting to each other. The steps 1025 and 1050 are comparable to the steps as discussed in context of FIG. 4. After that a stand alone UE to UE relay discovery and selection procedure 1019 is performed.

A UE (e.g., any type of UE, i.e. remote UE or relay) can initiate an integrated relay discovery and (re-)selection with PC5 link establishment by sending a PC5 link establishment request message, e.g. to relay nodes or other UEs. According to embodiments for the involved entities broadcast may be used for all (other) UEs, unicast is for a specific UE but can be relayed by a relay UE. The request message can be a
Broadcast message and/or
Unicast message
Groupcast/multicast

The request message can contain the required information for relay discovery and (re-) selection.

After that the per-hop PC5 link establishment between UE 1/UE 10 and selected relay UE 14 is done. This step is marked by the reference numeral 1213. In the step 1214 the four further steps for establishment as specified above can be performed. Note, the other steps as discussed in context of claim 4 may be part of the step 1214 or may be performed between the discussed steps.

For example, by reception of the PC5 direct link request message in a UE, the UE might decide to respond to the request by a PC5 Direct Communication Accept message. The decision of the UE to send accept message can be based on at least one out of followings:
A set of criteria is met (e.g. load in a UE, number of PC5 links, supported services, etc.)
Higher layer decision
Decision by the base station
Based on the (pre-)configurations in a UE
One or more measurements (e.g RSRP, CBR, buffer status)

The UE which sends the request message may receive one or more Accept messages. In case of several accept messages, the UE can perform relay (re-)selection.

According to embodiments, a first remote UE according to one of the previous claims which is further configured to transmit or receive a communication link establishment request message (e.g. Direct Communication Request message) using groupcast or multicast. According to embodiments, it is further configured to transmit or receive a link establish request message using broadcast or unicast. Note, the request message may contain information for relay discovery and (re) selection.

According to embodiments, the first remote UE or a second remote UE or the Relay UE is configured to decide to replay in terms of accepting (to accept) a request based on the following criteria:
A set of criteria is met (e.g., load in a UE, number of PC5 links, supported services, etc.)
Higher layer decision Decision by the base station
Based on the (pre-)configurations in a UE
One or more measurements (e.g., RSRP, CBR, buffer status).

### Embodiment 3: Content of PC5 Direct Link Establishment Request Message (DCR)

In addition to the existing fields in the PC5 direct link establishment request message, some additional data might be added to the request message or a new type/version/extension of request message can be introduced with at least one out of the following additional fields to integrate relay discovery and (re-)selection in it:
Source/target UE ID, e.g. a Layer-2 ID or local ID
Source/target UE application layer ID
Measurements (for e.g RSRP, CBR)
Indication for relaying request/capability
Load information of a UE (source, target, relay)
Number of the connected UEs (for e.g number of the PC5 links (active/inactive))
List of reachable UEs (e.g. from the upper layer point of view)
List of discoverable UEs (e.g. possibility to discover them through a discovery procedure)
QoS information (e.g. requirements regarding latency/reliability/throughput/round-trip delay/etc., flow information, etc.)
Available/required resources
Preferred and/or not preferred and/or required radio resources (e.g. frequencies, bandwidth parts, time slots)
DRX information (for e.g. sidelink DRX, Uu DRX)
HARQ feedback information
Cell ID of the connected cell
Neighbour cell ID (full list or limited list e.g considering an RSRP threshold)—this might be helpful in case of ongoing/coming handover)
PLMN ID
Location or distance information (UEs can provide their position or sidelink zone they are located in)
Indication for energy saving modes

The procedure using the request message DCR is discussed with respect to FIG. 6.

FIG. 6 shows the communication between a source UE 10s, a target UE 10t via a relay UE 14. First the source UE 10s sends the DCR to the relay 14 which, vice versa, sends the DCR to the target UE 10t (cf 1026+1051). Then the PC5 unicast link is established (per hop) between the target UE 10t and the relay (cf. step 1211), where the DCR accept message 1221 is transmitted. The DCR accept message 1222 is then forwarded by the UE relay 14 to the source UE 10s so as to perform PC5 unicast link establishment 1212 (per hop). The result is the established end-to-end security procedure. After that the entity and unicast link via U2U relay can be performed (cf. step 1225).

According to embodiments, the first remote UE is configured to transmit or receive a communication link establishment request comprising additional data out of the group:
Source UE and/or target UE ID, e.g. a Layer-2 ID or local ID
Source/target UE application layer ID
Measurements (for e.g., RSRP, CBR)
Indication for relaying request/capability
Load information of a UE (source, target, relay)
Number of the connected UEs (for e.g., number of the PC5 links (active/inactive))
List of reachable UEs (e.g., from the upper layer point of view)
List of discoverable UEs (e.g., possibility to discover them through a discovery procedure)
QoS information (e.g., requirements regarding latency/reliability/throuput/round-trip delay/etc., flow information, etc.)
Available/required resources
Preferred and/or not preferred and/or required radio resources (e.g., frequencies, bandwidth parts, time slots)
DRX information (for e.g., sidelink DRX, Uu DRX)
HARQ feedback information
Cell ID of the connected cell
Neighbour cell ID (full list or limited list e.g considering an RSRP threshold)—this might be helpful in case of ongoing/coming handover)
PLMN ID
Location or distance information (UEs can provide their position or sidelink zone they are located in)
Indication for energy saving modes.

Note the first remote UE may be configured to form a new version of the request message or an extended version of the request message comprising additional fields for the additional data.

### Embodiment 4: Content of PC5 Direct Communication Accept Message

Upon reception of PC5 link establishment request message, a UE might decide to respond to the request message using the PC5 Direct Communication Accept message or an extension or a new version of it with at least one out of the following additional fields for the integrated relay discovery and (re-)selection with PC5 link establishment:
Source/target UE ID, e.g. a Layer-2 ID or local ID
Source/target UE Application Layer ID
Measurements (for e.g RSRP, CBR)
Indication for relaying request/capability
Load information of a UE (source, target, relay)

Number of the connected UEs (for e.g number of the PC5 links (active/inactive))

List of reachable UEs (e.g. from the upper layer point of view)
List of discoverable UEs (e.g. possibility to discover them through a discovery procedure)
QoS information (e.g. requirements regarding latency/reliability/throuput/round-trip delay/etc., flow information, etc.)
Available/required resources
Preferred and/or not preferred and/or required radio resources (e.g. frequencies, bandwidth parts, time slots). Note, some conditions (e.g. DRX) may for example influence the amount of available resources.
DRX information (for e.g. sidelink DRX, Uu DRX)
HARQ feedback information
Cell ID of the connected cell
Neighbour cell ID (full list or limited list e.g considering an RSRP threshold)—this might be helpful in case of ongoing/coming handover)
PLMN ID
Location or distance information (UEs can provide their position or sidelink zone they are located in)
Indication for energy saving modes

According to embodiments, the first remote UE is configured to transmit or receive a direct communication accept message comprising additional data out of the group:
Source/target UE ID, e.g. a Layer-2 ID or local ID
Source/target UE Application Layer ID
Measurements (for e.g RSRP, CBR)
Indication for relaying request/capability
Load information of a UE (source, target, relay)
Number of the connected UEs (for e.g number of the PC5 links (active/inactive))
List of reachable UEs (e.g. from the upper layer point of view)
List of discoverable UEs (e.g. possibility to discover them through a discovery procedure)
QoS information (e.g. requirements regarding latency/reliability/throughput/round-trip delay/etc., flow information, etc.)
Available/required resources
Preferred and/or not preferred and/or required radio resources (e.g. frequencies, bandwidth parts, time slots)
DRX information (for e.g. sidelink DRX, Uu DRX)
HARQ feedback information
Cell ID of the connected cell
Neighbour cell ID (full list or limited list e.g considering an RSRP threshold)—this might be helpful in case of ongoing/coming handover)
PLMN ID
Location or distance information (UEs can provide their position or sidelink zone they are located in)
Indication for energy saving modes.

### Embodiment 5: Radio Link Failure (RLF) at PC5 Direct Link Between Two UEs

The direct PC5 link between two UEs may fail (e.g. Source/Relay, Target/Relay). In this case, at least one out the following might take place:
A new PC5 link establishments procedure with integrated discovery and (re-)selection
A discovery procedure and/or a relay (re-)selection

The relay/source/target UE can inform the other (connected) UE(s) about the RLF and trigger a relay discovery/(re-)selection or PC5 link establishment. It can also inform the other UE(s) about a high risk of RLF in case that measurements indicate this.

In case of in-coverage scenario, the gNodeB can assist the (re-)selection of a relay in order to reach the other remote UE in order to recover the PC5 link or establish a new link, e.g. a unicast PC5 connection or multicast.

According to embodiments, the first remote UE or the second remote UE or the Relay UE comprises an entity configured to determine a radio link failure or the risk of a radio link failure and to mandate to start the sidelink establishment procedure or to perform one of the following
Starting A new PC5 link establishment procedure with integrated discovery and (re-) selection
Performing A discovery procedure and/or a relay (re-)selection
Transmitting information to other (connected) UE(s) about the RLF and triggering a relay discovery/(re-)selection or PC5 link establishment.

In case of an in-coverage scenario or partially in-coverage scenario a gNodeB is used to assist the (re) selection by forwarding a (configuration) information or wherein in case of an out of coverage scenario the participants of the communication system forward communication information to assist the (re) selection procedure.

### Embodiment 6: Resources Used for Combined PC5 Discovery and/or (Re-)Selection

Resources for DCA/DCR can be at least one out of the following:
The combined PC5 relay discovery and (re-)selection messages can be sent in frequency bands from the frequency range FR1 and frequency bands from the frequency range FR2 as defined in the 3GPP Technical Specifications [5].
The resources for the PC5 link establishment procedure can be obtained through Mode 1 of sidelink resource allocation and/or Mode 2.
DCR/DCA messages can be sent within the common resource pool for sidelink or a dedicated resource pool for sidelink.
DCR/DCA messages can be sent on a dedicated channel defined by e.g. Layer 2 or destination ID or configured by gNodeB.

According to embodiments, the resources for exchanging a direction communication accept message and/or a direct link establishment request message (DCA/DCR) are out of the following:
frequency bands from the frequency range FR1 and frequency bands from the frequency range FR2 in the 3GPP technical specification;
obtained through mode 1 of sidelink resource allocation and/or mode 2; and/or
common resource pool for sidelink or dedicated resource pool for sidelink;
dedicated channel defined by, e.g., layer 2 or destination ID or configured by the gNodeB;
in case of in coverage scenario or partially in coverage scenario provided by the base station;
in case of out of coverage scenario selected or preconfigured.

For example, the sidelink establishment request message and the direct communication accept message are transmitted as a combined message.

According to embodiments, a system is provided having one or more remote UE (source and target) and an Relay UE.

Another embodiment provides a relay, referred to as Relay UE of a wireless [e.g., radio based] communication system [e.g., 5G/NR communication system], wherein the Relay UE is configured to operate in a sidelink mode of operation [e.g., 5G/NR sidelink mode 1 or mode 2]. The Relay UE is configured to establishing a connection between a first remote UE [e.g., source UE] and a second remote UE [e.g., target UE or a group of target UEs], and to initiate a sidelink establishment procedure; wherein the sidelink establishment procedure is mandated to start by a base station of the communication system, a road side unit of the communication system, the second UE or another UE of the communication system, the Relay UE or a higher layer of the first UE [e.g., self-initiated].

The features discussed in context of Embodiment 1-6 may be used for the Relay UE as well.

Further embodiments proved corresponding methods for performing wireless [e.g., radio based] communication [e.g., within 5G/NR communication system] using at least first remote UE [e.g., source UE] and a Relay UE, wherein the first remote UE is configured to operate in a sidelink mode of operation [e.g., 5G/NR sidelink mode 1 or mode 2], comprising the steps:
establishing a connection with a second remote UE [e.g., target UE or a group of target UEs] via a Relay UE, and
initiating a sidelink establishment procedure; wherein the sidelink establishment procedure is mandated to start
   by an external entity, like a base station of the communication system, a road side unit of the communication system, the second UE or another UE of the communication
   system, the Relay UE, or
   by action of a higher layer of the first UE [e.g., self-initiated] or
   in case of a radio link failure or the risk of a radio link failure.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 18 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] 3GPP TS 23.287 v17.3.0, Architecture enhancements for 5G System (5GS) to support
   Vehicle-to-Everything (V2X) services, (Release 17)
[2] 3GPP TR 23.752 v17.0.0—Study on system enhancement for Proximity based Services in 5G System
[3] 3GPP TR 23.700-33 v0.4.0 Study on system enhancement for Proximity based Services
   (ProSe) in the 5G System (5GS); Phase 2, (Release 18)
[4] 3GPP TS 38.331-Release 17 v17.2.0
[5] 3GPP TS 38.101-Release 17 v17.6.0

### Abbreviations

3GPP third generation partnership project
ACK acknowledgement
AIM assistance information message
AMF access and mobility management function
BS base station
BWP bandwidth part
CA carrier aggregation
CC component carrier
CBG code block group
CBR channel busy ratio
CQI channel quality indicator
CSI-RS channel state information-reference signal
CN core network
D2D device-to-device
DAI downlink assignment index
DCI downlink control information
DL downlink
DRX discontinuous reception
FFT fast Fourier transform
FR1 frequency range one
FR2 frequency range two
GMLC gateway mobile location center
gNB evolved node B (NR base station)/next generation node B base station
GSCN global synchronization channel number
HARQ hybrid automatic repeat request
IC in-coverage
ICS initial cell search
IoT internet of things
LCS location services
LMF location management function
LPP LTE positioning protocol
LTE long-term evolution
MAC medium access control
MCR minimum communication range
MCS modulation and coding scheme
MIB master information block
NACK negative acknowledgement
NB node B
NES network energy saving
NR new radio
NTN non-terrestrial network
NW network
OFDM orthogonal frequency-division multiplexing
OFDMA orthogonal frequency-division multiple access
OOC out of coverage
PBCH physical broadcast channel
P-UE pedestrian UE; not limited to pedestrian UE, but represents any UE with a need to save power, e.g., electrical cars, cyclists,
PC5 interface using the sidelink channel for D2D communication
PDCCH physical downlink control channel
PDSCH physical downlink shared channel
PLMN public land mobile network
PPP point-to-point protocol
PPP precise point positioning
PRACH physical random access channel
PRB physical resource block
ProSe proximity service
PSFCH physical sidelink feedback channel
PSCCH physical sidelink control channel
PSSCH physical sidelink shared channel
PUCCH physical uplink control channel
PUSCH physical uplink shared channel
RAIM receiver autonomous integrity monitoring
RAN radio access networks
RAT radio access technology
RB resource block
RNTI radio network temporary identifier
RP resource pool
RRC radio resource control
RS reference symbols/signal
RTT round trip time
SBI service based interface
SCI sidelink control information
SI system information
SIB sidelink information block
SL sidelink
SPI system presence indicator
SSB synchronization signal block
SSR state space representations
TB transport block
TTI short transmission time interval
TDD time division duplex
TDOA time difference of arrival
TIR target integrity risk
TRP transmission reception point
TTA time-to-alert
TTI transmission time interval
U2N UE to network
U2U UE to UE
UCI uplink control information
UE user equipment, e.g., a smartphone or IoT node
UL uplink
UMTS universal mobile telecommunication system
V2x vehicle-to-everything
V2V vehicle-to-vehicle
V2 vehicle-to-infrastructure
V2P vehicle-to-pedestrian
V2N vehicle-to-network
V-UE vehicular UE
VRU vulnerable road user
WUS wake-up signal
PC5 reference point between ProSe-enabled UEs used for control and user plane PC5 for 5G ProSe Direct Discovery, 5G ProSe Direct Communication and 5G ProSe UE-to-Network Relay.
DCR Direct Communication Request (PC5 connection link request)
DCA Direct Communication Answer (response to communication request)
RLF Radio Link Failure

1. A first remote UE [e.g., source UE] of a wireless [e.g., radio based] communication system [e.g., 5G/NR communication system],
wherein the first remote UE is configured to operate in a sidelink mode of operation [e.g., 5G/NR sidelink mode 1 or mode 2],
wherein the first remote UE is configured to establish a connection with a second remote UE [e.g., target UE or a group of target UEs] via a UE-to-UE-relay UE operated in the sidelink mode, and to initiate a sidelink establishment procedure;
wherein the sidelink establishment procedure is mandated to start
by an external entity, like a base station of the communication system, a road side unit of the communication system, the second UE or another UE of the communication system, the UE-to-UE-relay UE, or
by action of a higher layer of the first UE [e.g., self-initiated] or
in case of a radio link failure or the risk of a radio link failure.

2. The first remote UE according to claim 1, which is configured to transmit a communication link establishment request comprising additional data out of the group:
Source/target UE ID, e.g. a Layer-2 ID or local ID
Source/target UE application layer ID
Measurements (for e.g., RSRP, CBR)
Indication for relaying request/capability
Load information of a UE (source, target, relay)
Number of the connected UEs (for e.g., number of the PC5 links (active/inactive))
List of reachable UEs (e.g., from the upper layer point of view)
List of discoverable UEs (e.g., possibility to discover them through a discovery procedure)
QoS information (e.g., requirements regarding latency/reliability/throuput/round-trip delay/etc., flow information, etc.)
Available/required resources
Preferred and/or not preferred and/or required radio resources (e.g., frequencies, bandwidth parts, time slots)
DRX information (for e.g., sidelink DRX, Uu DRX)
HARQ feedback information.
Cell ID of the connected cell
Neighbour cell ID (full list or limited list e.g considering an RSRP threshold)
PLMN ID
Location or distance information (UEs can provide their position or sidelink zone they are located in)
Indication for energy saving modes.

3. The first remote UE according to claim 2, wherein the first remote UE is configured to form a new version of the request message or an extended version of the request message comprising additional fields for the additional data.

4. The first remote UE according to claim 1, wherein the first remote UE is configured to transmit or receive a direct communication accept message comprising additional data out of the group:
Source/target UE ID, e.g. a Layer-2 ID or local ID
Source/target UE Application Layer ID
Measurements (for e.g RSRP, CBR)
Indication for relaying request/capability
Load information of a UE (source, target, relay)
Number of the connected UEs (for e.g number of the PC5 links (active/inactive))
List of reachable UEs (e.g. from the upper layer point of view)
List of discoverable UEs (e.g. possibility to discover them through a discovery procedure)
QoS information (e.g. requirements regarding latency/reliability/throuput/round-trip delay/etc., flow information, etc.)
Available/required resources
Preferred and/or not preferred and/or required radio resources (e.g. frequencies, bandwidth parts, time slots)
DRX information (for e.g. sidelink DRX, Uu DRX)
HARQ feedback information
Cell ID of the connected cell
Neighbour cell ID (full list or limited list e.g considering an RSRP threshold)
PLMN ID
Location or distance information (UEs can provide their position or sidelink zone they are located in)
Indication for energy saving modes.

5. The first remote UE according to claim 1, wherein the first remote UE or the second remote UE or the UE-to-UE-relay UE comprises an entity configured to determine a radio link failure or the risk of a radio link failure and to mandate to start the sidelink establishment procedure or to perform one of the following
Starting A new PC5 link establishment procedure with integrated discovery and (re-) selection
Performing A discovery procedure and/or a relay (re-)selection
Transmitting information to other (connected) UE(s) about the radio link failure and triggering a relay discovery/(re-)selection or PC5 link establishment; or
wherein the first remote UE or the second remote UE or the UE-to-UE-relay UE comprises an entity configured to determine a radio link failure or the risk of a radio link failure and to mandate to start the sidelink establishment procedure or to perform one of the following
Starting A new PC5 link establishment procedure with integrated discovery and (re-) selection
Performing A discovery procedure and/or a relay (re-)selection
Transmitting information to other (connected) UE(s) about the radio link failure and triggering a relay discovery/(re-)selection or PC5 link establishment and
wherein in case of an in-coverage scenario or partially in-coverage scenario a gNodeB is used to assist the (re) selection by forwarding information, like configuration information or wherein in case of an out of coverage scenario the participants of the communication system forward communication information to assist the (re) selection procedure.

6. The first remote UE according to claim 1, wherein the first remote UE comprises a source UE and wherein the second remote UE comprises a target UE or a group of target UEs, or
wherein the first remote UE comprises a target UE or a group of target UEs and wherein the second remote UE comprises a source UE.

7. The first remote UE according to claim 1, wherein the first remote UE, the second remote UE or the UE-to-UE-relay UE comprises an entity configured to determine a radio link failure or the risk of a radio link failure; and/or
wherein the external entity communicates with the first remote UE using resources of layer 2/3 or of layer 1 for exchanging condition information or exchanging messages, and/or
which is further configured to transmit or receive a communication link establishment request message (e.g. Direct Communication Request message) using groupcast or multicast, and/or
which is further configured to transmit or receive a communication link establishment request message (e.g. Direct Communication Request message) using broadcast or unicast, and/or
wherein the request message comprises information for relay discovery and (re) selection.

8. The first remote UE according to claim 1, wherein the first remote UE or a second remote UE or the UE-to-UE-relay UE is configured to decide to reply to a request based on the following criteria:
A set of criteria is met (e.g., load in a UE, number of PC5 links, supported services, etc.)
Higher layer decision
Decision by the base station
Based on the (pre-)configurations in a UE
One or more measurements (e.g., RSRP, CBR, buffer status).

9. The first remote UE according to claim 1, wherein the resources for exchanging a direct communication accept message and/or a direct link establishment request message (DCA/DCR) are out of the following:
frequency bands from the frequency range FR1 and frequency bands from the frequency range FR2;
acquired through mode 1 of sidelink resource allocation and/or mode 2; and/or
common resource pool for sidelink or dedicated resource pool for sidelink;
dedicated channel defined by, e.g., layer 2 or destination ID or configured by the
in case of in coverage scenario or partially in coverage scenario provided by the base station;
in case of out of coverage scenario selected or preconfigured.

10. A UE-to-UE-relay UE of a wireless [e.g., radio based] communication system [e.g., 5G/NR communication system],
wherein the UE-to-UE-relay UE is configured to operate in a sidelink mode of operation [e.g., 5G/NR sidelink mode 1 or mode 2],
wherein the UE-to-UE-relay UE operated in the sidelink mode is configured to establishing a connection between a first remote UE [e.g., source UE] and a second remote UE [e.g., target UE or a group of target UEs], and to initiate a sidelink establishment procedure;
wherein the sidelink establishment procedure is mandated to start by a base station of the communication system, a road side unit of the communication system, the second UE or another UE of the communication system, the UE-to-UE-relay UE or a higher layer of the first UE [e.g., self-initiated].

11. The UE-to-UE-relay UE according to claim 10, which is configured to transmit or receive a communication link establishment request comprising additional data out of the group:
Source/target UE ID, e.g. a Layer-2 ID or local ID
Source/target UE application layer ID
Measurements (for e.g., RSRP, CBR)
Indication for relaying request/capability
Load information of a UE (source, target, relay)
Number of the connected UEs (for e.g., number of the PC5 links (active/inactive))
List of reachable UEs (e.g., from the upper layer point of view)
List of discoverable UEs (e.g. possibility to discover them through a discovery procedure)
QoS information (e.g., requirements regarding latency/reliability/throuput/round-trip delay/etc., flow information, etc.)
Available/required resources
Preferred and/or not preferred and/or required radio resources (e.g., frequencies, bandwidth parts, time slots)
DRX information (for e.g., sidelink DRX, Uu DRX)
HARQ feedback information
Cell ID of the connected cell
Neighbour cell ID (full list or limited list e.g., considering an RSRP threshold)
PLMN ID
Location or distance information (UEs can provide their position or sidelink zone they are located in)
Indication for energy saving modes.

12. The UE-to-UE-relay UE according to claim 10, which is configured to form a new version of the request message or an extended version of the request message comprising additional fields for the additional data, and/or
which is configured to transmit or receive a direct communication accept message comprising additional data out of the group:
Source/target UE ID, e.g. a Layer-2 ID or local ID
Source/target UE Application Layer ID
Measurements (for e.g RSRP, CBR)
Indication for relaying request/capability
Load information of a UE (source, target, relay)
Number of the connected UEs (for e.g number of the PC5 links (active/inactive))
List of reachable UEs (e.g. from the upper layer point of view)
List of discoverable UEs (e.g. possibility to discover them through a discovery procedure)
QoS information (e.g. requirements regarding latency/reliability/throuput/round-trip delay/etc., flow information, etc.)
Available/required resources
Preferred and/or not preferred and/or required radio resources (e.g. frequencies, bandwidth parts, time slots)
DRX information (for e.g. sidelink DRX, Uu DRX)
HARQ feedback information
Cell ID of the connected cell
Neighbour cell ID (full list or limited list e.g considering an RSRP threshold)
PLMN ID
Location or distance information (UEs can provide their position or sidelink zone they are located in)
Indication for energy saving modes.

13. The UE-to-UE-relay UE according to claim 10, wherein the first remote UE or the second remote UE or the UE-to-UE-relay UE comprises an entity configured to determine a radio link failure or the risk of a radio link failure and to mandate to start the sidelink establishment procedure or to perform one of the following
Starting A new PC5 link establishment procedure with integrated discovery and (re-) selection
Performing A discovery procedure and/or a relay (re-)selection
Transmitting information to other (connected) UE(s) about the RLF and triggering a relay discovery/(re-)selection or PC5 link establishment, or
wherein the first remote UE or the second remote UE or the UE-to-UE-relay UE comprises an entity configured to determine a radio link failure or the risk of a radio link failure and to mandate to start the sidelink establishment procedure or to perform one of the following
Starting A new PC5 link establishment procedure with integrated discovery and (re-) selection
Performing A discovery procedure and/or a relay (re-)selection
Transmitting information to other (connected) UE(s) about the RLF and triggering a relay discovery/(re-)selection or PC5 link establishment; and
wherein in case of an in-coverage scenario or partially in-coverage scenario a gNodeB is used to assist the (re) selection by forwarding information, like configuration information or wherein in case of an out of coverage scenario the participants of the communication system forward communication information to assist the (re) selection procedure.

14. The UE-to-UE-relay UE according to claim 10, wherein the first remote UE comprises a source UE and wherein the second remote UE comprises a target UE or a group of target UEs, and/or
wherein the first remote UE comprises a target UE or a group of target UEs and wherein the second remote UE comprises a source UE, and/or
wherein the first remote UE, the second remote UE or the UE-to-UE-relay UE comprises an entity configured to determine a radio link failure or the risk of a radio link failure, and/or
wherein the external entity communicates with the first remote UE using resources of layer 2/3 or of layer 1 for exchanging condition information or exchanging messages.

15. The UE-to-UE-relay UE according to claim 10, which is further configured to transmit or receive a communication link establishment request message using groupcast or multicast, or
which is further configured to transmit or receive a link establish request message using broadcast or unicast.

16. The UE-to-UE-relay UE according to claim 15, wherein the request message comprises information for relay discovery and (re) selection.

17. The UE-to-UE-relay UE according to claim 10, wherein the first remote UE or a second remote UE or the UE-to-UE-relay UE is configured to decide to reply request based on the following criteria
A set of criteria is met (e.g., load in a UE, number of PC5 links, supported services, etc.)
Higher layer decision
Decision by the base station
Based on the (pre-)configurations in a UE
One or more measurements (e.g., RSRP, CBR, buffer status); and/or
wherein the resources for exchanging a direction communication accept message and/or a direct link establishment request message (DCA/DCR) are out of the following:
frequency bands from the frequency range FR1 and frequency bands from the frequency range FR2;
acquired through mode 1 of sidelink resource allocation and/or mode 2; and/or
common resource pool for sidelink or dedicated resource pool for sidelink;
dedicated channel defined by, e.g., layer 2 or destination ID or configured by the
in case of in coverage scenario or partially in coverage scenario provided by the base station;
in case of out of coverage scenario selected or preconfigured.

18. A method for performing wireless [e.g., radio based] communication [e.g., within 5G/NR communication system] using at least first remote UE [e.g., source UE] and a UE-to-UE-relay UE, wherein the first remote UE is configured to operate in a sidelink mode of operation [e.g., 5G/NR sidelink mode 1 or mode 2], comprising:
establishing a connection with a second remote UE [e.g., target UE or a group of target UEs] via a UE-to-UE-relay UE operated in the sidelink mode, and
initiating a sidelink establishment procedure; wherein the sidelink establishment procedure is mandated to start
by an external entity, like a base station of the communication system, a road side
unit of the communication system, the second UE or another UE of the
communication
system, the UE-to-UE-relay UE, or
by action of a higher layer of the first UE [e.g., self-initiated] or
in case of a radio link failure or the risk of a radio link failure.

19. The method according to claim 18, comprising transmitting or receiving a communication link establishment request comprising additional data out of the group:
Source/target UE ID, e.g. a Layer-2 ID or local ID
Source/target UE application layer ID
Measurements (for e.g., RSRP, CBR)
Indication for relaying request/capability
Load information of a UE (source, target, relay)
Number of the connected UEs (for e.g., number of the PC5 links (active/inactive))
List of reachable UEs (e.g., from the upper layer point of view)
List of discoverable UEs (e.g., possibility to discover them through a discovery procedure)
QoS information (e.g., requirements regarding latency/reliability/throuput/round-trip delay/etc., flow information, etc.)
Available/required resources
Preferred and/or not preferred and/or required radio resources (e.g., frequencies, bandwidth parts, time slots)
DRX information (for e.g., sidelink DRX, Uu DRX)
HARQ feedback information
Cell ID of the connected cell
Neighbour cell ID (full list or limited list e.g considering an RSRP threshold)
PLMN ID
Location or distance information (UEs can provide their position or sidelink zone they are located in)
Indication for energy saving modes; and/or
comprising transmitting or receiving a direct communication accept message comprising additional data out of the group:
Source/target UE ID, e.g. a Layer-2 ID or local ID
Source/target UE Application Layer ID
Measurements (for e.g RSRP, CBR)
Indication for relaying request/capability
Load information of a UE (source, target, relay)
Number of the connected UEs (for e.g number of the PC5 links (active/inactive))
List of reachable UEs (e.g. from the upper layer point of view)
List of discoverable UEs (e.g. possibility to discover them through a discovery procedure)
QoS information (e.g. requirements regarding latency/reliability/throuput/round-trip delay/etc., flow information, etc.)
Available/required resources
Preferred and/or not preferred and/or required radio resources (e.g. frequencies, bandwidth parts, time slots)
DRX information (for e.g. sidelink DRX, Uu DRX)
HARQ feedback information
Cell ID of the connected cell
Neighbour cell ID (full list or limited list e.g considering an RSRP threshold)
PLMN ID
Location or distance information (UEs can provide their position or sidelink zone they are located in) Indication for energy saving modes; and/or
comprising determining a radio link failure or the risk of a radio link failure and to mandate to start the sidelink establishment procedure or to perform one of the following
Starting A new PC5 link establishment procedure with integrated discovery and (re-) selection
Performing A discovery procedure and/or a relay (re-)selection
Transmitting information to other (connected) UE(s) about the radio link failure and triggering a relay discovery/(re-)selection or PC5 link establishment.

20. A non-transitory digital storage medium having stored thereon a computer program for performing a method for performing wireless [e.g., radio based] communication [e.g., within 5G/NR communication system] using at least first remote UE [e.g., source UE] and a UE-to-UE-relay UE, wherein the first remote UE is configured to operate in a sidelink mode of operation [e.g., 5G/NR sidelink mode 1 or mode 2], the method comprising:
establishing a connection with a second remote UE [e.g., target UE or a group of target UEs] via a UE-to-UE-relay UE operated in the sidelink mode, and
initiating a sidelink establishment procedure; wherein the sidelink establishment procedure is mandated to start
by an external entity, like a base station of the communication system, a road side unit of the communication system, the second UE or another UE of the communication
system, the UE-to-UE-relay UE, or
by action of a higher layer of the first UE [e.g., self-initiated] or
in case of a radio link failure or the risk of a radio link failure,
when the computer program is run by a computer.
